(19) United States
(12) Patent Application Publication
(10) Pub. No.: US 2011/0202913 A1
(43) Pub. Date: Aug. 18, 2011

(54) SYSTEM, METHOD, AND COMPUTER PROGRAM PRODUCT FOR SOFTWARE DISTRIBUTION

(76) Inventor: Tatsuo NISHIMURA, Tokyo (JP)

(21) Appl. No.: 13/013,252

(22) Filed: Jan. 25, 2011

(30) Foreign Application Priority Data
Feb. 16, 2010 (JP) 2010-031808

(51) Int. Cl. G06F 9/445

(52) U.S. Cl. 717/178

(57) ABSTRACT

A software distribution system includes a software distribution server that distributes software; an image processing apparatus; an information processing apparatus; and an activation server that performs license authentication for software installed on the image processing apparatus. The information processing apparatus includes a selection receiving unit that receives designation of software as software to be installed on the image processing apparatus; and a distribution-request transmitting unit that transmits a request for distribution of the designation-received software to the software distribution server. The image processing apparatus includes a download control unit that downloads the designation-received software from the software distribution server; an installation control unit that performs installation of the downloaded software; and an activation control unit that performs, concurrently with the installation of the downloaded software, activation of the downloaded software to place the downloaded software in an enabled state under the license authenticated by the activation server.

The present application claims priority to and incorporates by reference the entire contents of Japanese Patent Application No. 2010-031808 filed in Japan on Feb. 16, 2010.

### BACKGROUND OF THE INVENTION

1. Field of the Invention

The present invention is directed generally to a system, a method, and a computer program product for software distribution.

2. Description of the Related Art

Methods for adding a function to a device through a network have hitherto been known. For instance, there has been known a method that includes accessing a server that provides a package file of the function, downloading the file into the device, installing the downloaded file on the device, and accessing an installed-function-activating server to perform operation (hereinafter, “activation”) that enables the installed function.

However, the conventional method disadvantageously requires user's time and trouble of performing operations because the activation, which is a final process, is performed after a package file has been downloaded and installed.

To this end, a system that, in order to facilitate operations of a user who adds a computer program, determines whether the computer program can run in an operating environment of a terminal of the user and displays a list that contains only computer programs determined to be capable of running on the terminal is disclosed in Japanese Patent Application Laid-open No. 2002-14784, for instance.

However, the technique disclosed in Japanese Patent Application Laid-open No. 2002-014784 is disadvantageous in not being capable of reducing time and user operation required for installation and activation that are to be performed after download.

### SUMMARY OF THE INVENTION

It is an object of the present invention to at least partially solve the problems in the conventional technology.

According to an aspect of the present invention, there is provided a software distribution system that includes a software distribution server that distributes software; an image processing apparatus; an information processing apparatus that requests distribution of software to be installed on the image processing apparatus; and an activation server that performs license authentication for software installed on the image processing apparatus. The information processing apparatus includes a selection receiving unit that receives designation of software as software to be installed on the image processing apparatus; and a distribution-request transmitting unit that transmits a request for distribution of the designation-received software to the software distribution server. The image processing apparatus includes a download control unit that downloads the designation-received software from the software distribution server; an installation control unit that performs installation of the downloaded software; and an activation control unit that performs, concurrently with the installation of the downloaded software, activation of the downloaded software to place the downloaded software in an enabled state under the license authenticated by the activation server.

According to another aspect of the present invention, there is provided a software distribution method to be performed in a software distribution system. The system includes a software distribution server that distributes software; an image processing apparatus; an information processing apparatus that requests distribution of software to be installed on the image processing apparatus; and an activation server that performs license authentication for software installed on the image processing apparatus. The software distribution method includes receiving, by the information processing apparatus, designation of software as software to be installed on the image processing apparatus; transmitting, by the information processing apparatus, a request for distribution of the designation-received software to the software distribution server; downloading, by the image processing apparatus, the designation-received software from the software distribution server; installing, by the image processing apparatus, the downloaded software; and performing, by the image processing apparatus, concurrently with the installing of the downloaded software, activation of the downloaded software to place the downloaded software in an enabled state under the license authenticated by the activation server.

According to still another aspect of the present invention, there is provided a computer program product comprising a computer-usable medium having computer-readable program codes embodied therein and executed in an image processing apparatus connected to an information processing apparatus that requests distribution of software to be installed on the image processing apparatus, and an activation server that performs license authentication for software installed on the image processing apparatus. The program codes causes the image processing apparatus to execute a software distribution method. The method includes downloading, from the software distribution apparatus, software designated through the information processing apparatus as software to be installed on the image processing apparatus; installing the downloaded software; and performing concurrently with the installing of the downloaded software, activation of the downloaded software to place the downloaded software in an enabled state under the license authenticated by the activation server.

The above and other objects, functions, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating the configuration of a software distribution system according to an embodiment of the present invention;

FIG. 2 is a block diagram illustrating a functional configuration of an information processing apparatus according to the embodiment;

FIG. 3 is a block diagram illustrating a functional configuration of an activation server according to the embodiment;

FIG. 4 is a block diagram illustrating a functional configuration of a software distribution server according to the embodiment;

FIG. 5 is a schematic hardware configuration diagram of a device according to the embodiment;

FIG. 6 is a schematic software configuration diagram of the device;

FIG. 7 is a block diagram illustrating a functional configuration of an application-installation control service in the device;

FIG. 8 is an explanatory diagram illustrating control flow of a conventional enabling process;

FIG. 9A is an explanatory diagram illustrating an example enabling process to be performed by the software distribution system;

FIG. 9B is an explanatory diagram illustrating another example enabling process to be performed by the software distribution system;

FIG. 10 is a flowchart illustrating a procedure for a list creating process to be performed by the information processing apparatus;

FIG. 11 is a schematic diagram illustrating an example entry screen, from which information for use in utilizing a function package is to be entered;

FIG. 12 is a schematic diagram illustrating an example function-selection screen;

FIG. 13 is a schematic diagram illustrating example precedence-relation rules according to the embodiment;

FIG. 14 is a schematic diagram illustrating an example operation-sequence determining process performed by an operation-sequence determining unit according to the embodiment;

FIG. 15 is a sequence diagram illustrating a procedure for a cancellation process to be performed in a situation where an attempt by the device to perform the enabling process has failed;

FIG. 16 is a schematic diagram illustrating an example screen for receiving a cancellation selection input;

FIG. 17 is an explanatory diagram illustrating control flow of a sequential process performed by the device;

FIG. 18 is an explanatory diagram illustrating a cancellation process to be performed in a situation where an attempt by the device to perform the sequential process has failed;

FIG. 19 is a schematic diagram illustrating an example screen for receiving a cancellation selection input; and

FIG. 20 is a timing diagram of a license issuing process performed by the activation server.

### DETAILED DESCRIPTION OF THE PREFERRED EMBODIMENTS

Preferred embodiments of the present invention are described in detail below with reference to the accompanying drawings. The embodiments will be described by way of examples, in each of which a device according to an aspect of the invention is embodied in an multifunction peripheral (MFP) that has at least two functions of a copier function, a printer function, a scanner function, and a facsimile function; however, the device is not limited thereto.

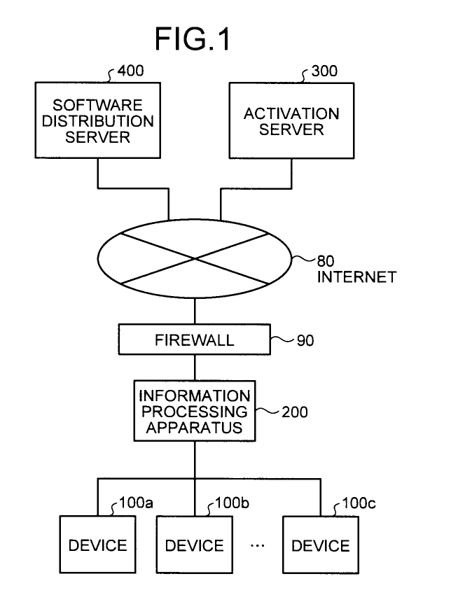

FIG. 1 is a block diagram illustrating the configuration of a software distribution system according to an embodiment of the present invention. As illustrated in FIG. 1, the software distribution system includes a software distribution server 400, an activation server 300, an information processing apparatus 200, and a plurality of devices 100a, 100b, and 100c (hereinafter, “device 100” is used to denote a not-specified one of the devices) that are connected to one another with a network 80, such as the Internet. A firewall 90 is provided between the network 80 and the devices 100.

The firewall 90 monitors traffic passing across a boundary from outside, and detects and blocks unauthorized electronic access so as to prevent unauthorized operation performed by a third party that has intruded into the software distribution system via an external network, such as a public line or the Internet.

Each of the devices 100 has a plurality of functions to serve as a copier, a facsimile, a printer, and the like. The devices 100 are connected to one another through a local network, such as a local area network (LAN). In the embodiment, the three devices, or, more specifically, the devices 100a, 100b, and 100c, are connected to the software distribution system according to the embodiment; however, the number of the devices 100 is not limited to three, and the software distribution system can include one, two, four, or more online MFPs.

The software distribution server 400 contains application for use by the devices 100 and provides the applications to the devices 100.

The activation server 300 is an apparatus that manages licenses (authorizations) of applications that are provided by the software distribution server 400 and can be installed on the devices 100.

To provide remote management, each device in the software distribution system of the embodiment has a function of exchanging, with another device in the system, a request for performing a method of an application that is implemented by the device and a response thereto by using remote procedure call (RPC). The software distribution system is also capable of utilizing protocols, such as simple object access protocol (SOAP) and file transfer protocol (FTP) to implement RPC.

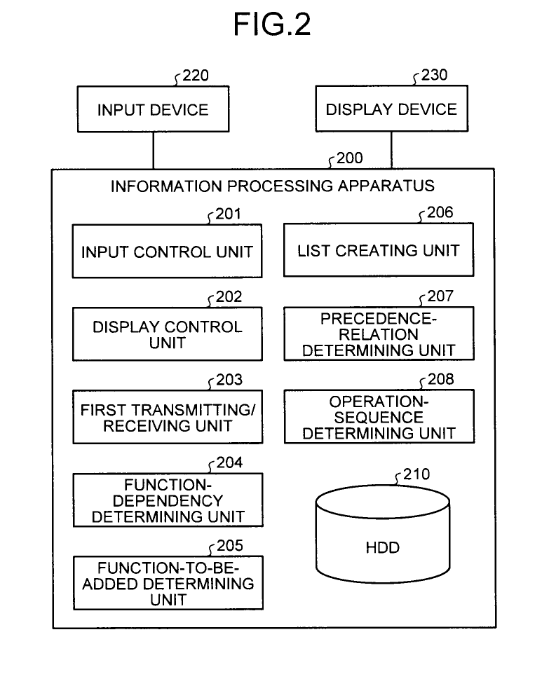

A functional configuration of the information processing apparatus 200 is described below. FIG. 2 is a block diagram illustrating the functional configuration of the information processing apparatus 200. As illustrated in FIG. 2, the information processing apparatus 200 includes an input control unit 201, a display control unit 202, a first transmitting/receiving unit 203, a function-dependency determining unit 204, a function-to-be-added determining unit 205, a list creating unit 206, a precedence-relation determining unit 207, an operation-sequence determining unit 208, and a hard disk drive (HDD) 210 and is connected to an input device 220 and to a display device 230.

The display control unit 202 displays various items on the display device 230. The display control unit 202 displays, for example, function software packages (hereinafter, “function packages”) that can be installed on the device 100 in form of selectable options and an operation-setting screen for setting operations of software installed on the device 100.

The input control unit 201 receives an input entered by a user with the input device 220. For instance, the input control unit 201 receives an input of information for use in utilizing a function package. More specifically, the input control unit 201 receives, as a function package to be installed on the device 100, a designation of a function package selected from the installable function packages displayed by the display control unit 202, designation of a license type, and the like. The input control unit 201 also receives a disabling selection input that instructs that a disabling process is to be performed. The disabling process disables, in a situation where designation of a plurality of packages has been received and an attempt to install or activate one portion of the function packages has failed, installation and activation of all the function packages. The input control unit 201 corresponds to a selection receiving unit and a disabling receiving unit.

The HDD 210 stores function dependency, precedence relation, and the like. The function dependency defines, in a situation where a plurality of functions are selected, one function needs to be installed together with another function so that the one function can operate properly. The precedence relation defines, in a situation where a plurality of functions are selected, an operation sequence of installation or activation of the functions so that one function of the functions can be installed or activated properly. The precedence relation is defined as relationship between functions. The HDD 210 stores therein each of the function dependency and the precedence relation as a rule on a function-by-function basis. In each rule, a function is associated with another function having function dependency therewith. The information processing apparatus 200 obtains the function dependency and the precedence relation from the software distribution server 400.

The list creating unit 206 creates a list of functions contained in the function package, designation of which has been received by the input control unit 201 and which is to be installed on the device 100. When the function-to-be-added determining unit 205 has determined a function to be added to the list, the list creating unit 206 adds the function to the list. When the operation-sequence determining unit 208 has determined an operation sequence, the list creating unit 206 rearranges functions in the list according to the operation sequence determined by the operation-sequence determining unit 208.

The function-dependency determining unit 204 determines whether the list contains a function having function dependency with another function, by accessing the HDD 210.

If the function-dependency determining unit 204 has determined that the list contains a function having function dependency with another function, the function-to-be-added determining unit 205 accesses the HDD 210 to determine the other function to be added.

The precedence-relation determining unit 207 determines whether the list contains a function, about which precedence relation is defined, by accessing the HDD 210.

If it is determined that the list contains a function, about which precedence relation is defined, the operation-sequence determining unit 208 accesses the HDD 210 to determine an operation sequence of functions in the list.

The first transmitting/receiving unit 203 transmits input items received by the input control unit 201 to a corresponding server and/or to the device 100. For instance, the first transmitting/receiving unit 203 transmits a request for distribution (hereinafter, “distribution request”) of a function package to the software distribution server 400 and transmits a list to the device 100. The distribution request requests for distribution of a function package to be installed on the device 100 and contains a device ID of the device 100, a list that contains functions of the function package to be installed on the device 100, and the like.

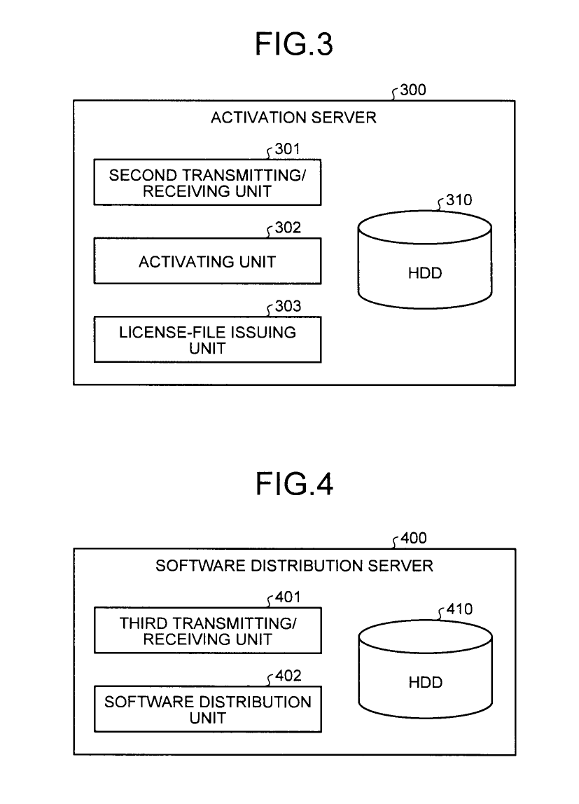

A functional configuration of the activation server 300 is described below. FIG. 3 is a block diagram illustrating the functional configuration of the activation server 300. As illustrated in FIG. 3, the activation server 300 includes a second transmitting/receiving unit 301, an activating unit 302, a license-file issuing unit 303, and an HDD 310.

The HDD 310 stores license information. The license information is information about license that permits the device 100 to use a function package. The license information contains, for instance, a product key associated with the license and expiration time of the license.

Upon receiving an activation request from the device 100, the activating unit 302 verifies license information stored in the HDD 310 and activates a function package specified in the activation request. The activation request is a request for authentication of a license for the function package.

The license-file issuing unit 303 receives the product key from the device 100 via the information processing apparatus 200, validates the product key by accessing the HDD 310, and, if the product key is validated, issues a license file. More specifically, the license-file issuing unit 303 compares the received product key with an already-issued product key stored in the HDD 310, and validates the product key if they match.

The second transmitting/receiving unit 301 exchanges various information with the information processing apparatus 200 and the devices 100. For instance, the second transmitting/receiving unit 301 receives an activation-start instruction from the information processing apparatus 200 and receives a product key from the device 100. The second transmitting/receiving unit 301 transmits the license file issued by the license-file issuing unit 303 to the device 100.

A functional configuration of the software distribution server 400 is described below. FIG. 4 is a block diagram illustrating the functional configuration of the software distribution server 400. As illustrated in FIG. 4, the software distribution server 400 includes a third transmitting/receiving unit 401, a software distribution unit 402, and an HDD 410.

The HDD 410 stores therein function packages, function dependency, precedence relation, and the like. The third transmitting/receiving unit 401 receives a distribution request from the information processing apparatus 200.

Upon receiving the distribution request from the information processing apparatus 200, the software distribution unit 402 obtains, from the HDD 410, a function package listed on a list contained in the distribution request. The software distribution unit 402 transmits the obtained function package to the device 100 associated with the device ID in the distribution request via the third transmitting/receiving unit 401.

The third transmitting/receiving unit 401 exchanges various information with the information processing apparatus 200 and the devices 100. For instance, the third transmitting/receiving unit 401 receives a distribution request from the information processing apparatus 200 and transmits the function package obtained by the software distribution unit 402 to the device 100.

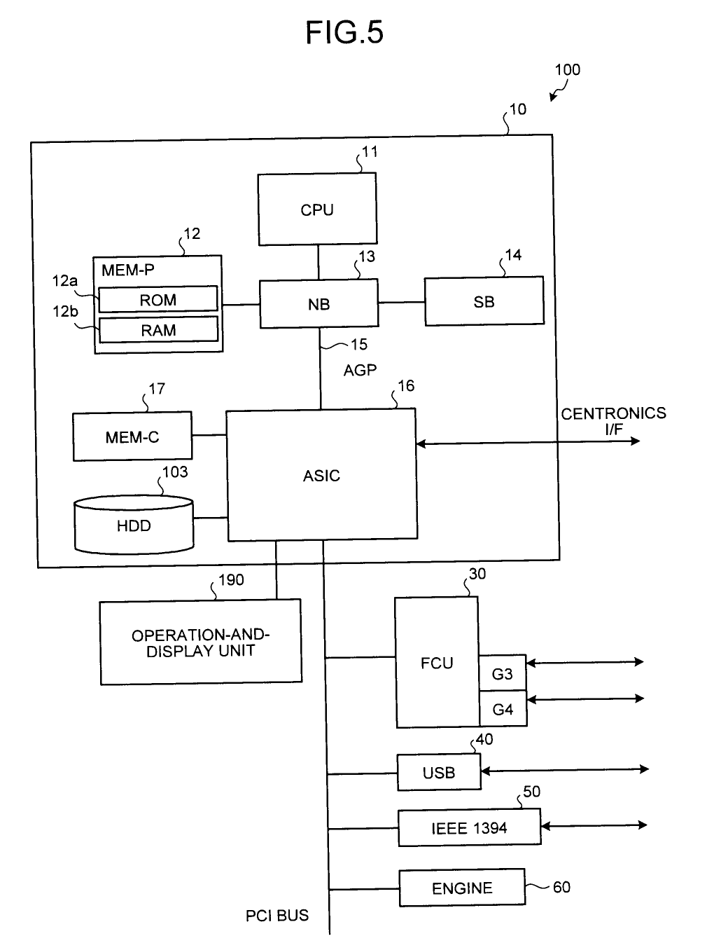

The device 100 is described below. FIG. 5 is a schematic hardware configuration diagram of the device 100 according to the embodiment. As illustrated in FIG. 5, the device 100 includes a controller 10 and an engine 60 that are connected together with a peripheral component interface (PCI) bus. The controller 10 is a controller that controls the overall device 100, rendering, communications, and input entered via an operating unit (not shown). The engine 60 is a printer engine or the like that is connectable to the PCI bus. Examples of the engine 60 include a monochrome plotter, a one-drum color plotter, a four-drum color plotter, a scanner, and a facsimile unit. The engine 60 includes, in addition to what is called an engine section such as the plotter, an image processing section that performs error diffusion, gamma conversion, and the like.

The controller 10 includes a central processing unit (CPU) 11, a north bridge (NB) 13, a system memory (hereinafter, “MEM-P”) 12, a south bridge (SB) 14, a local memory (hereinafter, “MEM-C”) 17, an application-specific integrated circuit (ASIC) 16, and an HDD 103. An accelerated graphics port (AGP) bus 15 connects between the NB 13 and the ASIC 16. The MEM-P 12 includes a read only memory (ROM) 12a and a random access memory (RAM) 12b.

The CPU 11 that controls the overall device 100 includes a chip set that includes the NB 13, the MEM-P 12, and the SB 14. The CPU 11 is connected to another device via the chip set.

The NB 13 is a bridge for connecting the CPU 11 to the MEM-P 12, the SB 14, and the AGP 15. The NB 13 includes a PCI master, an AGP target, and a memory controller that controls reading and writing from and to the MEM-P 12 and the like.

The MEM-P 12 that includes the ROM 12a and the RAM 12b is a system memory for use as memory for storing computer program instructions (hereinafter, “program”) and data, a memory for loading programs and data thereinto, a memory for use in rendering for the printer, and the like. The ROM 12a is a read only memory for use as memory for storing programs and data. The RAM 12b is a writable and readable memory for use as memory for loading programs and data thereinto, a memory for use in rendering for the printer, and the like.

The SB 14 is a bridge for connecting the NB 13 to a PCI device and peripheral devices. The SB 14 is connected to the NB 13 via the PCI bus, to which a network interface (I/F) and the like are also connected.

The ASIC 16 is an integrated circuit (IC) for use in image processing. The ASIC 16 includes a hardware component for the image processing and functions as a bridge that connects the AGP 15, the PCI bus, the HDD 103, and the MEM-C 17 with each other. The ASIC 16 includes a PCI target and an AGP master, an arbiter (ARB) serving as the core for the ASIC 16, a memory controller that controls the MEM-C 17, a plurality of direct memory access controllers (DMACs) that performs data processing related to rotation of an image and the like by hardware logic, and a PCI unit that performs data transfer to and from the engine unit 60 via the PCI bus. A facsimile control unit (FCU) 30, a universal serial bus (USB) 40, and an IEEE 1394 (the Institute of Electrical and Electronics Engineers 1394) I/F 50 are connected to the ASIC 16 via the PCI bus. An operation-and-display unit 190 is directly connected to the ASIC 16.

The MEM-C 17 is a local memory for use as a copy image buffer and a code buffer. The HDD 103 is a storage for storing image data, computer programs, font data, and forms.

The AGP 15 is a bus interface for a graphics accelerator card introduced to speed up graphics operations and allows direct access to the MEM-P 12 with a high throughput, thereby speeding up operations related to the graphic accelerator card.

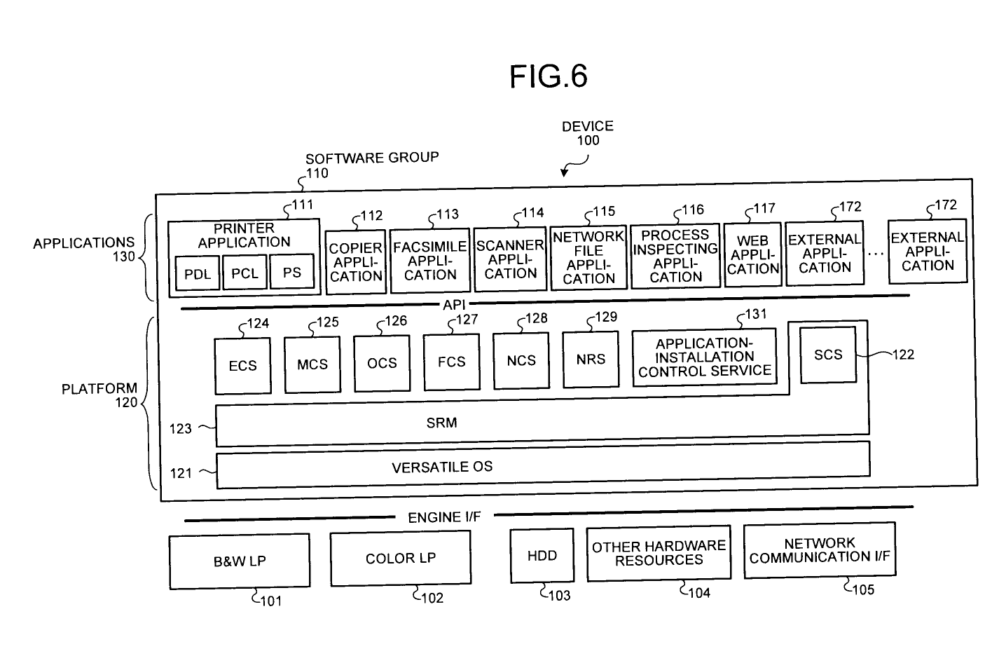

FIG. 6 is a schematic software configuration diagram of the device 100 according to the embodiment. As illustrated in FIG. 6, the device 100 includes a black-and-white laser printer (B&W LP) 101, a color laser printer (color LP) 102, the HDD 103, hardware resources 104, such as a scanner, a facsimile, and memory, a network communication I/F 105, and a software group 110 that includes a platform 120 and applications 130.

The platform 120 includes control services, each of which interprets a process request fed from an application and issues a resource request for a hardware resource, a system resource manager (SRM) 123 that manages one or more hardware resources and arbitrates resource requests from the control service, and a versatile operating system (OS) 121.

The control service includes a plurality of service modules, or specifically a system control service (SCS) 122, an engine control service (ECS) 124, a memory control service (MCS) 125, an operation panel control service (OCS) 126, a facsimile control service (FCS) 127, a network control service (NCS) 128, a new remote service (NRS) 129, and an application-installation control service 131. The platform 120 includes an application program interface (API) that allows receipt of processing request from the applications 130 by using functions defined in advance.

The versatile OS 121, which is a versatile operating system such as UNIX (registered trademark), executes software programs of the platform 120 and the applications 130 concurrently as parallel processes.

The SRM 123 performs a process for system control and resource management in cooperation with the SCS 122. More specifically, the SRM 123 performs a process for arbitration, execution, and control according to a request fed from an upper layer that uses hardware resource, such as an engine of a scanner unit, a printer unit, or the like, memory, an HDD file, or a host input/output (I/O) (e.g., a Centronics-compatible I/F, a network I/F, an IEEE 1394 (the Institute of Electrical and Electronics Engineers 1394) I/F, or an RS-232C I/F).

More specifically, the SRM 123 determines whether the requested hardware resource is available (i.e., whether the requested hardware resource is currently used for another request), and if the requested hardware resource is available, sends a notification that the requested hardware resource is available to the upper layer. The SRM 123 also arranges, in response to a request from the upper layer, a schedule for utilization of hardware resource and directly performs a requested operation (e.g., memory allocation, file creation, or causing a printer engine to perform paper feeding and image forming).

The SCS 122 performs a process for application management, control of an operating unit, displaying system-related screens, indication with light-emitting diodes (LEDs), resource management, control of application interruption, and the like.

The ECS 124 performs a process for engine control of the hardware resources 104 that include the B&W LP 101, the color LP 102, the scanner, and the facsimile.

The MCS 125 performs a process for allocation and release of image memory, utilization of the HDD, compression and decompression of image data, and the like.

The FCS 127 performs a process for provision of an API that allows facsimile transmission to and reception from each application layer of a system controller by using a public switched telephone network (PSTN) or an integrated services digital network (ISDN) network, storing and retrieving facsimile data in and from a backup SRAM (BKM) that manages various facsimile data pieces, scanning for facsimile transmission, printing of received facsimile data, and transmission and reception by using combined functions.

The NCS 128 performs a process for provision of services that are common among applications that require network I/O. More specifically, the NCS 128 intermediates allocation of data pieces, which are received via the network by using various protocols, to the applications and data transmission from the applications to the network.

In the present embodiment, the NCS 128 performs a process for receiving an installation request and an uninstallation request in addition to receiving an application and license information. When an application has successfully been installed according to an installation request, the NCS 128 notifies the information processing apparatus 200 of completion of installation. In contrast, when an attempt to install an application according to an installation request has failed, the NCS 128 notifies the information processing apparatus 200 of uncompleted installation. When an application has successfully been uninstalled according to an uninstallation request, the NCS 128 notifies the information processing apparatus 200 of completion of uninstallation. In contrast, when an attempt to uninstall an application according to an uninstallation request has failed, the NCS 128 transmits notifies the information processing apparatus 200 of uncompleted uninstallation.

The OCS 126 performs a process for control of an operation panel (control panel) that serves as an interface between an operator (user) and control of the apparatus. When a key is pressed (or touched) on the operation panel, the OCS 126 recognizes it as a key event. The OCS 126 includes a portion serving as an OCS process that transmits a key event function corresponding to the thus-recognized key to the SCS 122 and a portion serving as an OCS library. In the OCS library, rendering functions that cause various images to be rendered and displayed on the operation panel according to a request from any one of the applications 130 and the control services, other control functions for the operation panel, and the like are stored in advance. The OCS library is implemented as being linked with various modules of the applications 130 and the control services. The entire OCS 126 can be configured so as to operate as the OCS process. Alternatively, the entire OCS 126 can be configured as the OCS library.

The application-installation control service 131 performs a process for installing the received application under the license information according to the installation request received in the process performed by the NCS 128. The application-installation control service 131 performs a process for uninstalling application under the received license information according to the uninstallation request received in the process performed by the NCS 128.

The NRS 129 performs a process for a function related to device remote management via the network, such as data conversion for transmission and reception of data via the network, and a scheduler function.

The applications 130 include a printer application 111 that is an application for a printer that has a page description language (PDL) and a post script (PS), a copier application 112 that is an application for a copier, a facsimile application 113 that is an application for a facsimile, a scanner application 114 that is an application for a scanner, a network file application 115 that is an application for a network file, a process inspecting application 116 that is an application for process inspection, and a web application 117 that serves as a web server (hypertext transfer protocol (http) server) and displays various screens on a web browser that is executed on a client terminal.

Each of processes performed by the applications 130 and the processes performed by the control services provides a user service related to image forming operation such as a copier, a printer, a scanner, a facsimile, or the like by performing function call and return value transmission in response to the function call and exchanging messages for inter-process communications.

As described above, the device 100 according to the embodiment includes the plurality of applications 130 and the plurality of control services, each of which is run as a process. One or multiple threads are generated in each of the processes so that simultaneous multi-threading is performed. The control services provide the applications 130 with common control services. This allows a large number of processes to run in a multi-tasking and multi-threading manner while carrying out inter-process communications to cooperate with one another, thereby providing a user with services related to image forming, such as the copier function, the printer function, the scanner function, and the facsimile function.

The device 100 is configured such that a third party, such as a customer or a third vendor, of the device 100 can develop an external application 172 and install the external application 172 on an application layer, which is an upper layer of a control service layer. The external application 172 is an application fed from the information processing apparatus 200 and to be installed by the application-installation control service 131.

In the device 100 according to the embodiment, the plurality of processes of the plurality of applications 130 and the plurality of processes of the control services are run; however, another configuration, in which a single process of the applications 130 is run and a single process of the control services in run, can alternatively employed. Application can be added to or deleted from the applications 130 on an application-by-application basis. Put another way, the external application 172 can be installed on or uninstalled from the device 100 in a similar manner as described above.

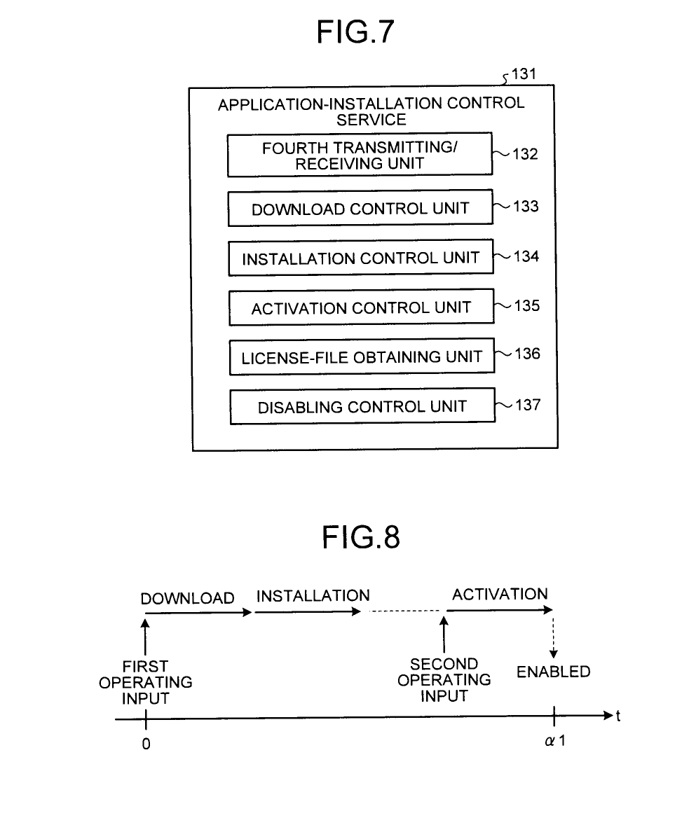

The application-installation control service 131 is described in detail below. FIG. 7 is a block diagram illustrating a functional configuration of the application-installation control service 131. As illustrated in FIG. 7, the application-installation control service 131 includes a fourth transmitting/receiving unit 132, a download control unit 133, an installation control unit 134, an activation control unit 135, a license-file obtaining unit 136, and a disabling control unit 137.

The fourth transmitting/receiving unit 132 exchanges various information with the information processing apparatus 200, the activation server 300, and the software distribution server 400. For instance, the fourth transmitting/receiving unit 132 receives a list from the information processing apparatus 200 and receives a function package from the software distribution server 400. The fourth transmitting/receiving unit 132 also transmits a notification of completion of download, a notification of completion of installation, a notification of completion of activation, and the like to the information processing apparatus 200.

The download control unit 133 downloads a function package distributed from the software distribution server 400. If the download is successfully completed, the download control unit 133 transmits a notification of completion of download to each of the information processing apparatus 200 and the software distribution server 400 whereas, if an attempt of download has failed, the download control unit 133 transmits a notification of failed download attempt to the same.

The installation control unit 134 installs the function package downloaded by the download control unit 133. If the installation is successfully completed, the installation control unit 134 transmits a notification of completion of installation to the information processing apparatus 200 whereas, if an attempt of installation has failed, the installation control unit 134 transmits a notification of failed installation attempt to the same.

The activation control unit 135 activates the function package downloaded by the download control unit 133 concurrently with the installation performed by the installation control unit 134. Meanwhile, activation is a process performed to place a downloaded function package in an enabled state under a license authenticated by the activation server 300. When the activation is successfully completed, the activation control unit 135 transmits a notification of completion of activation to each of the information processing apparatus 200 and the activation server 300 whereas, when an attempt of activation has failed, the activation control unit 135 transmits a notification of failed activation attempt to each of the information processing apparatus 200 and the activation server 300.

After completion of the activation, the license-file obtaining unit 136 obtains a license file for the activated function package from the activation server 300.

If any one of an attempt by the installation control unit 134 to perform the installation and an attempt by the activation control unit 135 to perform the activation has failed, the disabling control unit 137 cancels the installation and the activation. When a failure occurs during a process, in which a plurality of function packages are sequentially installed or activated, the disabling control unit 137 disables all functions inclusive of a function that has been successfully installed or activated.

A process for enabling function package in the software distribution system configured as described above is described below. An enabling process is a series of operations including download of a function package into the device 100, and installing and activating the downloaded package to thereby enable the function package.

First, an example of a conventional enabling process is described below. FIG. 8 is an explanatory diagram illustrating control flow of the conventional enabling process. As illustrated in FIG. 8, in the conventional enabling process, upon receiving a first user operating input, a device downloads a function package and installs the downloaded function package. Upon receiving a second user operating input after completion of installation of the function package, the device activates the installed function package. Hence, the device completes the activation, to thereby place the function package in an enabled state after a lapse of α1 from receipt of the operating input.

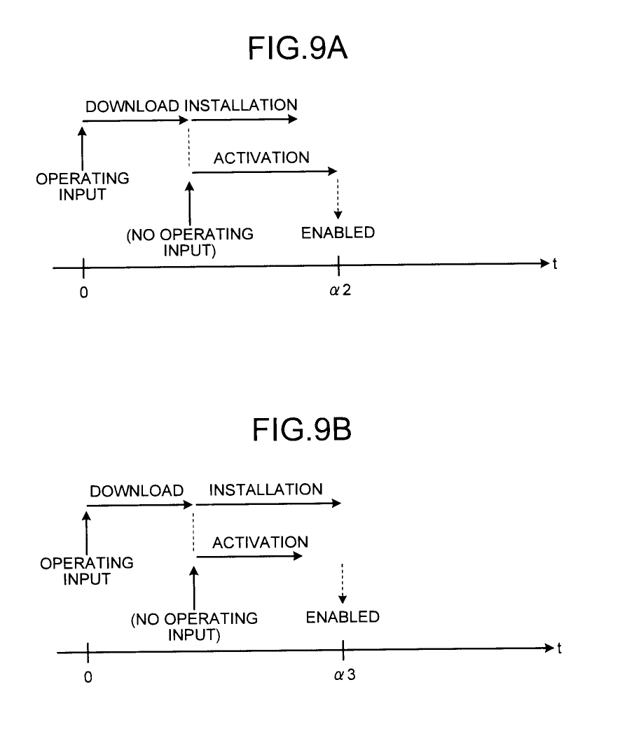

An enabling process in the software distribution system according to the embodiment is described below. FIG. 9A is an explanatory diagram illustrating an example enabling process to be performed by the software distribution system according to the embodiment. As illustrated in FIG. 9A, in the enabling process performed by the software distribution system, upon receiving a user operating input for starting the enabling process, the device 100 downloads a function package and successively performs installation and activation. Hence, the device 100 completes the activation to thereby place the function package in an enabled state after a lapse of α2 from receipt of the operating input. In this case, α2, which is time when the function package is enabled, is at completion of the activation because the activation is completed after completion of the installation.

Another example enabling process to be performed by the software distribution system according to the embodiment is described below. FIG. 9B is an explanatory diagram illustrating the other example enabling process to be performed by the software distribution system according to the embodiment. As illustrated in FIG. 9B, as in the example described with reference to FIG. 9A, upon receiving a user operating input for starting the enabling process, the device 100 downloads a function package and successively performs installation and activation. The device 100 completes the activation to thereby place the function package in an enabled state after a lapse of α3 from receipt of the operating input. In the example illustrated in FIG. 9B, α3, which is time when the function package is enabled, is at completion of the installation because the installation is completed after completion of the activation.

As illustrated in FIG. 9A and FIG. 9B, the device 100 starts activation and installation concurrently. Accordingly, a period of time that elapses from receipt of a user operating input until a function package is enabled is shorter than that in the conventional example. This can be expressed as: α2<α1 and α3<α1.

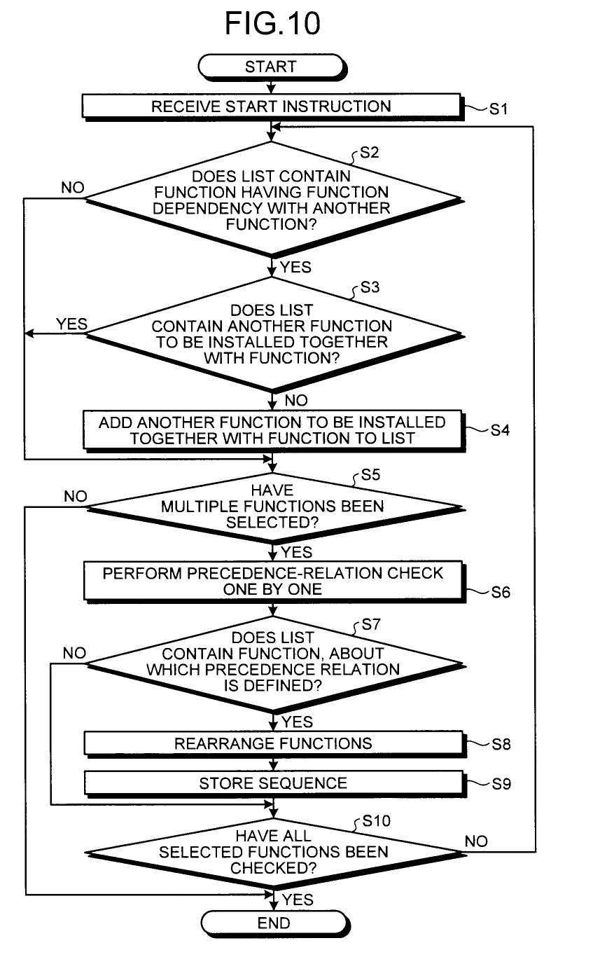

A list creating process performed by the information processing apparatus 200 is described below. FIG. 10 is a flowchart illustrating a procedure for the list creating process performed by the information processing apparatus 200.

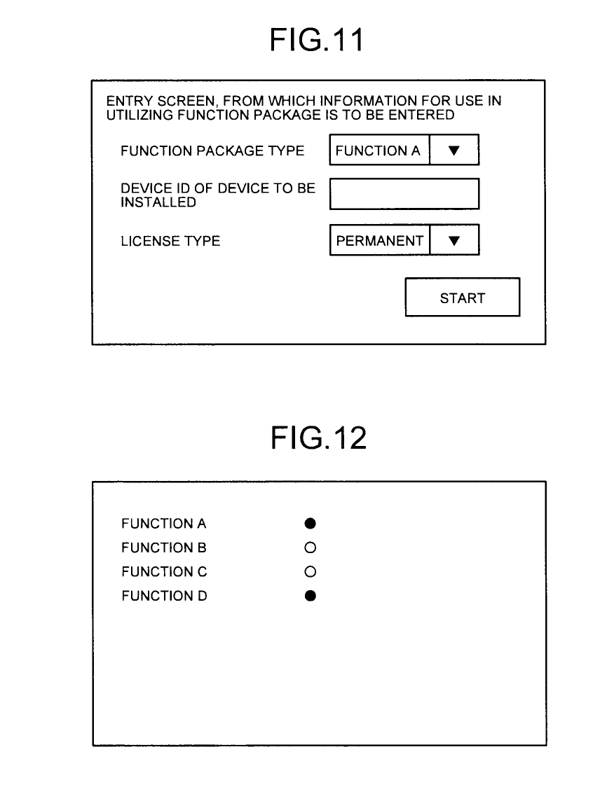

The input control unit 201 receives an input of information for use in utilizing a function package to be installed on the device 100, and thereafter receives an input of an instruction to start the enabling process for the function package (Step S1). FIG. 11 is a schematic diagram illustrating an example entry screen, from which information for use in utilizing a function package is to be entered. As illustrated in FIG. 11, the display control unit 202 displays an entry screen that allows entry of a function package type, device ID of an MFP to be installed, a license type, and a start instruction on the display device 230.

The display control unit 202 displays all the functions contained in the function package selected from the entry screen illustrated in FIG. 11 as selectable options. FIG. 12 is a schematic diagram illustrating an example function-selection screen. As illustrated in FIG. 12, the display control unit 202 displays functions A through D from top to bottom in an order of operation sequence. The display control unit 202 highlights a function selected with a click by a user. FIG. 12 illustrates an example where the function A and the function D have been clicked by a user. The list creating unit 206 adds the functions selected in this manner to the list.

The function-dependency determining unit 204 accesses the HDD 210 to determine whether the list created by the list creating unit 206 contains a function having function dependency with another function (Step S2). When the function-dependency determining unit 204 has determined that the list contains a function having function dependency with another function (Yes at Step S2), the function-to-be-added determining unit 205 determines whether the list contains the other function (Step S3).

If it is determined the list does not contain the other function to be installed together with the function (No at Step S3), the function-to-be-added determining unit 205 accesses the HDD 210 and adds the other function to be installed together with the function, to the list (Step S4). In contrast, if the function-dependency determining unit 204 has determined that the list does not contain a function having function dependency with another function (No at Step S2) or if the function-to-be-added determining unit 205 has determined that the list contains the other function package to be installed together with the function (Yes at Step S3), process control proceeds to Step S5.

The precedence-relation determining unit 207 determines whether the list contains a plurality of functions (Step S5). If it is determined that the list contains a plurality of functions (Yes at Step S5), the precedence-relation determining unit 207 accesses the HDD 210 (Step S6) to determine whether the list contains a function, about which precedence relation is defined (Step S7).

If the precedence-relation determining unit 207 has determined that the list contains a function, about which precedence relation is defined (Yes at Step S7), the operation-sequence determining unit 208 sorts functions in the list according to the precedence relation (Step S8).

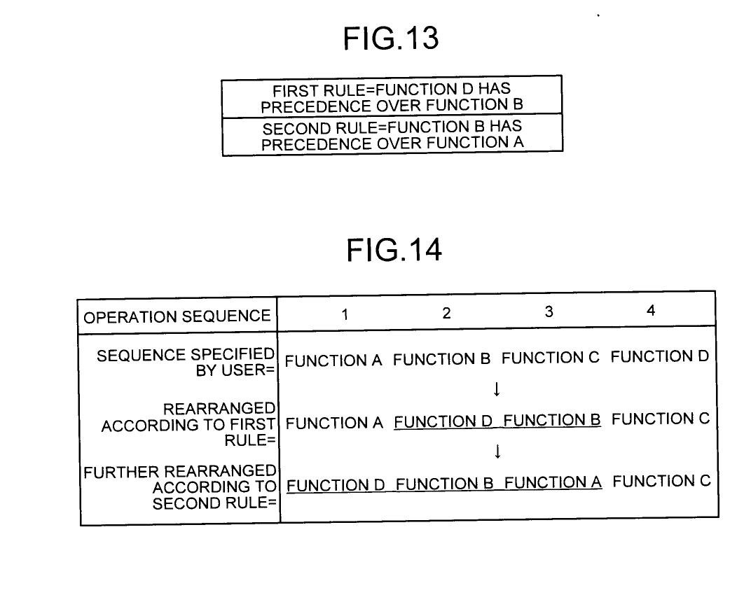

An example precedence relation is described below. FIG. 13 is a schematic diagram illustrating example precedence-relation rules. With reference to FIG. 13, the HDD 210 stores a first rule “the function D has precedence over the function B” and a second rule “the function B has precedence over the function A” as precedence relation.

FIG. 14 is a schematic diagram illustrating an example operation-sequence determining process performed by the operation-sequence determining unit 208. As illustrated in FIG. 14, in a situation where a user specifies an operation sequence “the function A, the function B, the function C, and the function D”, the operation-sequence determining unit 208 first rearranges the functions into an operation sequence “the function A, the function D, the function B, and the function C” according to the first rule. Subsequently, the operation-sequence determining unit 208 rearranges the functions into an operation sequence “the function D, the function B, the function A, and the function C” according to the second rule.

The operation-sequence determining unit 208 stores the sequence rearranged according to the precedence relation in the HDD 210 (Step S9). The precedence-relation determining unit 207 determines whether determination has been made for every function in the list (Step S10).

If the precedence-relation determining unit 207 has determined that determination has been made for every function in the list (Yes at Step S10), the precedence-relation determining process ends. In contrast, if the precedence-relation determining unit 207 has determined that determination has not been made for every function in the list (No at Step S10), processing from Step S2 to Step S9 is repeated.

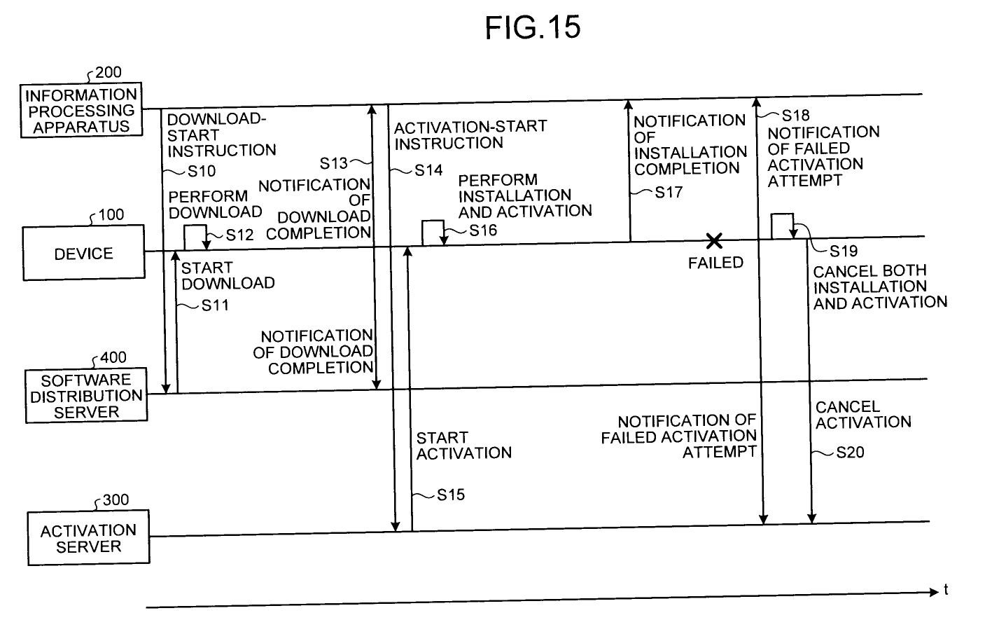

A cancellation process to be performed in a situation where an attempt by the device 100 to perform the enabling process has failed is described. The cancellation process is a process performed by the device 100 to cancel both installation and activation when at least any one of an attempt to perform the installation and an attempt to perform the activation has failed. FIG. 15 is a sequence diagram illustrating a procedure for the cancellation process for a situation where an attempt by the device 100 to perform an enabling process has failed. This cancellation process premises that the information processing apparatus 200 has received in advance, at the time of receiving user input from the entry screen, a cancellation selection input that instructs that the cancellation process is to be performed when an attempt of the enabling process has failed.

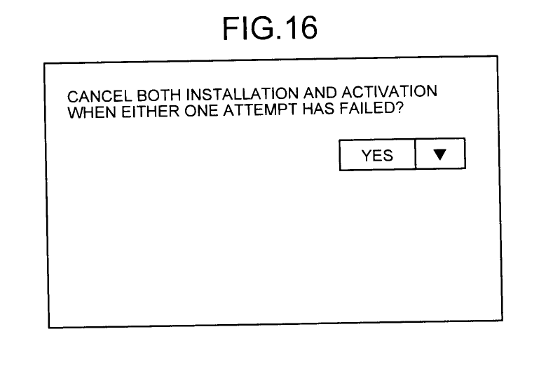

For instance, the information processing apparatus 200 receives a cancellation selection input that instructs that the cancellation process is to be performed when an attempt to perform an enabling process has failed. FIG. 16 is a schematic diagram illustrating an example screen for receiving the cancellation selection input. As illustrated in FIG. 16, the information processing apparatus 200 displays a pull-down menu containing “Yes” and “No” options with a comment “CANCEL BOTH INSTALLATION AND ACTIVATION WHEN EITHER ONE ATTEMPT HAS FAILED?” User selection input of “Yes” with a click causes the information processing apparatus 200 to receive the cancellation selection input.

The information processing apparatus 200 transmits a download-start instruction to the software distribution server 400 (Step S10). The device 100 starts download of a function package from the software distribution server (Step S11). The device 100 downloads the function package from the software distribution server 400 (S12). Upon completing download of the function package from the software distribution server 400, the device 100 transmits a notification of completion of download to each of the information processing apparatus 200 and the software distribution server 400 (Step S12).

Upon receiving the notification of completion of download from the device 100 (Step S13), the information processing apparatus 200 transmits an activation-start instruction to the activation server 300 (Step S14). Upon receiving the activation-start instruction from the information processing apparatus 200, the activation server 300 activates the function package downloaded into the device 100 (Step S15). When the activation server 300 starts activation of the function package downloaded from the software distribution server 400, the device 100 performs installation concurrently with the activation (Step S16).

Upon completion of the installation, the device 100 transmits a notification of completion of installation to the information processing apparatus 200 (Step S17). If an attempt to perform the activation having been started concurrently with the installation has failed, the device 100 transmits a notification of failed activation attempt to each of the information processing apparatus 200 and the activation server 300 (Step S18).

The device 100 cancels both the installation and the activation (Step S19). Although an example where the device 100 cancels both the installation and the activation because of the failed activation attempt has been described, also in a case where an installation attempt has failed prior to activation, the device 100 similarly cancels both the installation and activation. The device 100 transmits an activation-cancellation notification to the activation server 300 (Step S20). This transmission of a cancellation notification allows the activation server 300 to cancel the activation, thereby preventing charging for a not-enabled function.

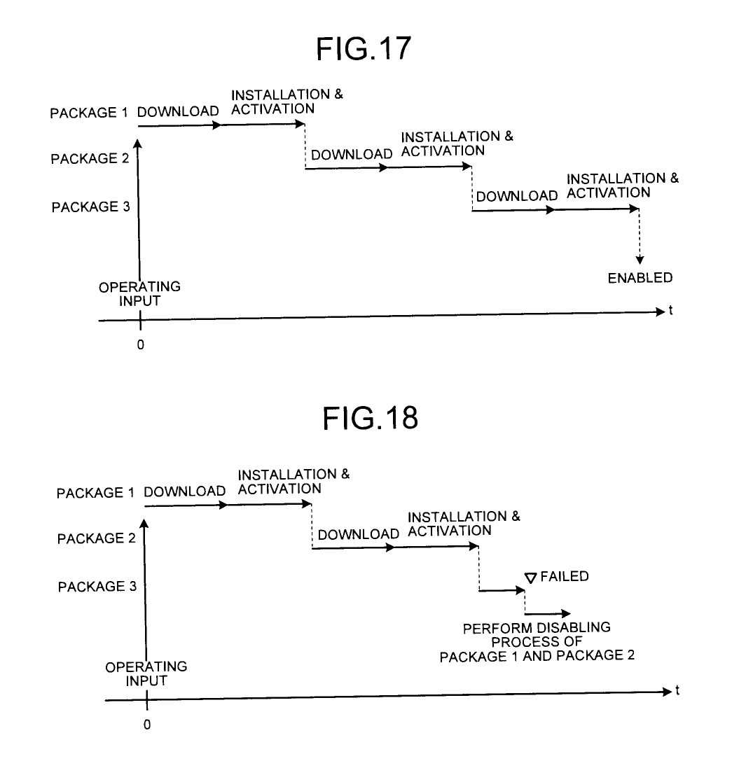

A process (hereinafter, “sequential process”) performed by the device 100 to sequentially enable a plurality of function packages is described below. FIG. 17 is an explanatory diagram illustrating control flow of the sequential process performed by the device 100.

With reference to FIG. 17, the device 100 performs the sequential process to enable three function packages, or, more specifically, a package 1, a package 2, and a package 3. The information processing apparatus 200 receives designation of the package 1, the package 2, and the package 3 as function packages to be subjected to the enabling process and an input that instructs to start the enabling process of these function packages. The device 100 first downloads the package 1 from the software distribution server 400, and installs and activates the package 1. Subsequently, the device 100 downloads the package 2 from the software distribution server 400, and installs and activates the package 2. The device 100 further downloads the package 3 from the software distribution server 400, and installs and activates the package 3.

A cancellation process for a situation where an attempt by the device 100 to perform the sequential process has failed is described. FIG. 18 is an explanatory diagram illustrating the cancellation process in the situation where an attempt by the device 100 to perform the sequential process illustrated in FIG. 17 has failed. This cancellation process premises that the information processing apparatus 200 has received in advance, at the time of receiving user input from the entry screen, a cancellation selection input that instructs that the cancellation process is to be performed when an attempt to perform as small as a portion of the sequential process has failed.

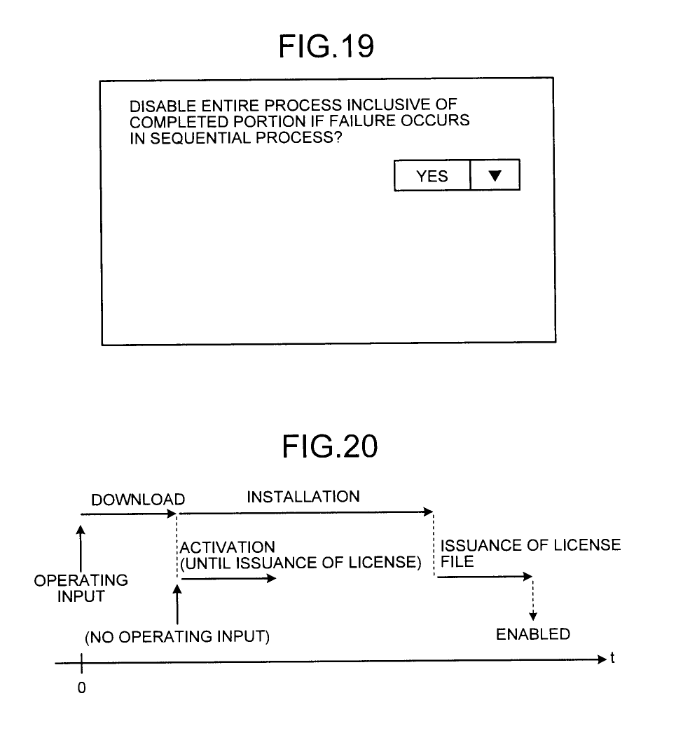

For instance, the information processing apparatus 200 receives a cancellation selection input that instructs that the cancellation process is to be performed when an attempt to perform the enabling process has failed. FIG. 19 is a schematic diagram illustrating an example screen for receiving the cancellation selection input. As illustrated in FIG. 19, the information processing apparatus 200 displays a pull-down menu containing “Yes” and “No” options with a comment “DISABLE ENTIRE PROCESS INCLUSIVE OF COMPLETED PORTION IF FAILURE OCCURS IN SEQUENTIAL PROCESS?” User selection input of “Yes” with a click causes the information processing apparatus 200 to receive the cancellation selection input for the sequential process.

Referring back to FIG. 18, the device 100 performs the sequential process of the package 1, the package 2, and the package 3 as described above with reference to FIG. 17. The device 100 first downloads the package 1 from the software distribution server 400, and installs and activates the package 1. Subsequently, the device 100 downloads the package 2 from the software distribution server 400, and installs and activates the package 2. Subsequently, the device 100 downloads the package 3 from the software distribution server 400, and starts installation and activation of the package 3; however, if an attempt to install the package 3 or an attempt to activate the package 3 has failed, the device 100 performs the disabling process to disable the package 1 and the package 2 that have already been installed and activated.

There can be such a sequential process that requires all of a plurality of function packages in the process to be enabled so that as small as a portion of the function packages can be used. In consideration of such a sequential process, the entire sequential process is disabled even when a failure occurs only in a portion of the sequential process in the configuration discussed above.

A license issuing process performed by the activation server 300 is described below. FIG. 20 is a timing diagram of the license issuing process performed by the activation server 300. As illustrated in FIG. 20, the information processing apparatus 200 receives an input that instructs to start the process. Upon receiving the input, the device 100 starts download of a function package from the software distribution server 400. The activation server 300 performs activation of the function package concurrently with installation of the function package performed by the device 100. The activation server 300 issues a license file after completion of the activation performed by the activation server 300 and the installation performed by the device 100. The device 100 is permitted to use the function package from a point in time when the device 100 has received the license file from the activation server 300.

The activation server 300 generally issues a license file after completion of activation. A fee is generally charged after the license file has been issued. Accordingly, causing the activation server 300 to issue a license file after a function package has been successfully installed prevents a situation that a fee is erroneously charged when an attempt to install a function package has failed.

As described above, according to the embodiment, the device 100 starts, after download of software, installation and activation of the software concurrently. This not only reduces a period of time that elapses from start of download until the software is enabled but also facilitates user operation.

As described above, according to the present embodiment, the device 100 performs the sequential process to sequentially enable a plurality of function packages. This leads to reduction in processing time and facilitates user operation.

As described above, according to the present embodiment, charging a fee for installation and activation of a function package that cannot be used alone can be prevented. This also prevents useless installation of a function package, thereby preventing memory space from being occupied for no use.

The software distribution program to be executed on the device 100 according to the embodiment can be provided in a computer-readable recording medium such as a compact disc-read-only memory (CD-ROM), a flexible disk (FD), a CD recordable (CD-R), or a digital versatile disk (DVD) in an installable or executable format.

The software distribution program to be executed by the device 100 according to the embodiment can be configured to be stored in a computer connected to a network, such as the Internet, so that the program is provided by downloading via the network. The software distribution program to be executed by the device 100 according to the embodiment can be configured to be provided or distributed via a network, such as the Internet.

The software distribution program according to the embodiment can be configured to be provided as being installed in a ROM or the like in advance.

The software distribution program to be executed by the device 100 according to the embodiment have a module structure that includes the units (the download control unit, the installation control unit, the activation control unit, the license-file obtaining unit, and the disabling unit) described above. From the viewpoint of actual hardware, the CPU (processor) reads the software distribution program from the storage medium and executes the program to load the units on a main memory device, thereby generating the download control unit, the installation control unit, the activation control unit, the license-file obtaining unit, and the disabling unit on the main memory device.

According to an aspect of the present invention, a period of time that elapses from when download of software is started until the software is enabled can be reduced. In addition, user operation can be facilitated.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A software distribution system comprising:
a software distribution server that distributes software;
an image processing apparatus;
an information processing apparatus that requests distribution of software to be installed on the image processing apparatus; and
an activation server that performs license authentication for software installed on the image processing apparatus, wherein
the information processing apparatus includes:
a selection receiving unit that receives designation of software as software to be installed on the image processing apparatus; and
a distribution-request transmitting unit that transmits a request for distribution of the designation-received software to the software distribution server, and
the image processing apparatus includes:
a download control unit that downloads the designation-received software from the software distribution server;
an installation control unit that performs installation of the downloaded software; and
an activation control unit that performs, concurrently with the installation of the downloaded software, activation of the downloaded software to place the downloaded software in an enabled state under the license authenticated by the activation server.

2. The software distribution system of claim 1, wherein
the selection receiving unit receives designation of a plurality of software components as the software to be installed on the image processing apparatus;
the installation control unit sequentially performs installation of the plurality of designation-received software components; and
the activation control unit sequentially performs activation of the plurality of designation-received software components.

3. The software distribution system of claim 1, wherein the image processing apparatus further includes a disabling control unit that determines whether at least one of an attempt to install the downloaded software and an attempt to activate the downloaded software has failed and, if the disabling control unit has determined that the at least one of the attempts has failed, disables both the installation and the activation.

4. The software distribution system of claim 3, wherein
the information processing apparatus further includes a disabling receiving unit that receives a disabling selection input that instructs to disable both the installation and the activation, and
upon receiving the disabling selection input, the disabling control unit disables both the installation and the activation.

5. The software distribution system of claim 1, wherein
the selection receiving unit receives designation of a plurality of software components as the software to be installed on the image processing apparatus,
the image processing apparatus further includes:
a storage unit that stores therein precedence relation that defines an operation sequence any one of the installation and the activation of the plurality of designation-received software components is to be performed; and
an operation-sequence determining unit that accesses the storage unit to determine an operation sequence of the plurality of designation-received software components,
the installation control unit performs installation of the plurality of designation-received software components according to the operation sequence determined by the operation-sequence determining unit, and
the activation control unit activates the plurality of designation-received software components according to the operation sequence determined by the operation-sequence determining unit concurrently with the installation.

6. The software distribution system of claim 1, wherein
the selection receiving unit receives designation of a plurality of software components as the software to be installed on the image processing apparatus,
the image processing apparatus further includes a storage unit that stores therein function dependency that defines that a software component of the designation-received software components needs to be installed and activated together with another software component,
the installation control unit performs installation of the designation-received software components and the other software component defined by the function dependency, and
the activation control unit performs the activation concurrently with the installation of the designation-received software components and the other software component.

7. The software distribution system of claim 1, wherein
the activation server further includes:
a license issuing unit that issues a license that authorizes use of the software after the downloaded software has been installed; and
a license transmitting unit that transmits the license issued by the license issuing unit to the image processing apparatus,
the image processing apparatus further includes a license receiving unit that receives the license from the activation server.

8. A software distribution method to be performed in a software distribution system that includes:
a software distribution server that distributes software;
an image processing apparatus;
an information processing apparatus that requests distribution of software to be installed on the image processing apparatus; and
an activation server that performs license authentication for software installed on the image processing apparatus, the software distribution method comprising:
receiving, by the information processing apparatus, designation of software as software to be installed on the image processing apparatus;
transmitting, by the information processing apparatus, a request for distribution of the designation-received software to the software distribution server;
downloading, by the image processing apparatus, the designation-received software from the software distribution server;
installing, by the image processing apparatus, the downloaded software; and
performing, by the image processing apparatus, concurrently with the installing of the downloaded software, activation of the downloaded software to place the downloaded software in an enabled state under the license authenticated by the activation server.

9. A computer program product comprising a computer-usable medium having computer-readable program codes embodied therein and executed in an image processing apparatus connected to an information processing apparatus that requests distribution of software to be installed on the image processing apparatus, and an activation server that performs license authentication for software installed on the image processing apparatus, the program codes causing the image processing apparatus to execute a software distribution method comprising:
downloading, from the software distribution apparatus, software designated through the information processing apparatus as software to be installed on the image processing apparatus;
installing the downloaded software; and
performing concurrently with the installing of the downloaded software, activation of the downloaded software to place the downloaded software in an enabled state under the license authenticated by the activation server.
